(19) United States
(12) Patent Application Publication
(10) Pub. No.: US 2013/0305573 A1
(43) Pub. Date: Nov. 21, 2013

(54) GREETING CARD WITH LIGHT AND SOUND

(71) Applicant: AMERICAN GREETINGS CORPORATION, Cleveland, OH (US)

(72) Inventors: April Nemeth, Westlake, OH (US); Gary Nelson, Avon, OH (US); Seth Larson, Lakewood, OH (US)

(73) Assignee: American Greetings Corporation, Cleveland, OH (US)

(21) Appl. No.: 13/832,132

(22) Filed: Mar. 15, 2013

Related U.S. Application Data
(60) Provisional application No. 61/649,414, filed on May 21, 2012.

(51) Int. Cl. B42D 15/02

(52) U.S. Cl. CPC B42D 15/022
USPC 40/124.02

(57) ABSTRACT

An interactive greeting card is described herein having a protective housing within which the electronic components are contained and concealed. The protective housing is covered in a multiple panel construct or enclosure which forms a greeting card around the housing. A small compartment in a center portion of the protective housing contains an expandable banner which can be unfolded or pulled away from the greeting card to trigger initiation of a sound clip and illumination of one or more lights.

### RELATED APPLICATIONS

The present application claims priority to U.S. Provisional Patent Application No. 61/649,414, filed on May 21, 2012, a copy of which is incorporated herein by reference.

### FIELD OF THE INVENTION

The present invention is in the field of social expression products, more specifically interactive greeting cards having light and sound capabilities.

### BACKGROUND OF THE INVENTION

For many years paper greeting cards containing text sentiment and associated artwork have been widely used for celebratory occasions such as birthdays, graduations, weddings, and for other commercial purposes. More recently, greeting cards have been enhanced by incorporating sound and other effects. Sound generating devices have been incorporated into traditional paper greeting cards to increase entertainment value and emotional impact. In some forms, a talking or musical greeting card looks just like a conventional greeting card, except that it includes a hidden sound module with a pre-recorded sound track. Opening the greeting card will automatically turn on or close a switch so that the sound module will play the pre-stored music or dialog and closing the greeting card will automatically open the switch and stop the play of the music or dialog.

There is a need in the art for a greeting card that increases the entertainment value and raises the surprise factor of traditional or sound generating greeting cards and incorporates user interactive elements.

### SUMMARY OF THE INVENTION

An interactive greeting card is described herein having a protective housing within which the electronic components are contained and concealed. The protective housing is covered in a multiple panel construct or enclosure which forms a greeting card around the housing. A small compartment in a center portion of the protective housing contains an expandable banner which can be unfolded or pulled away from the greeting card to trigger initiation of a sound clip and illumination of one or more lights.

### DESCRIPTION OF THE DRAWINGS

FIG. 1 is a perspective view of the greeting card of the present invention with the expandable banner in a closed position.

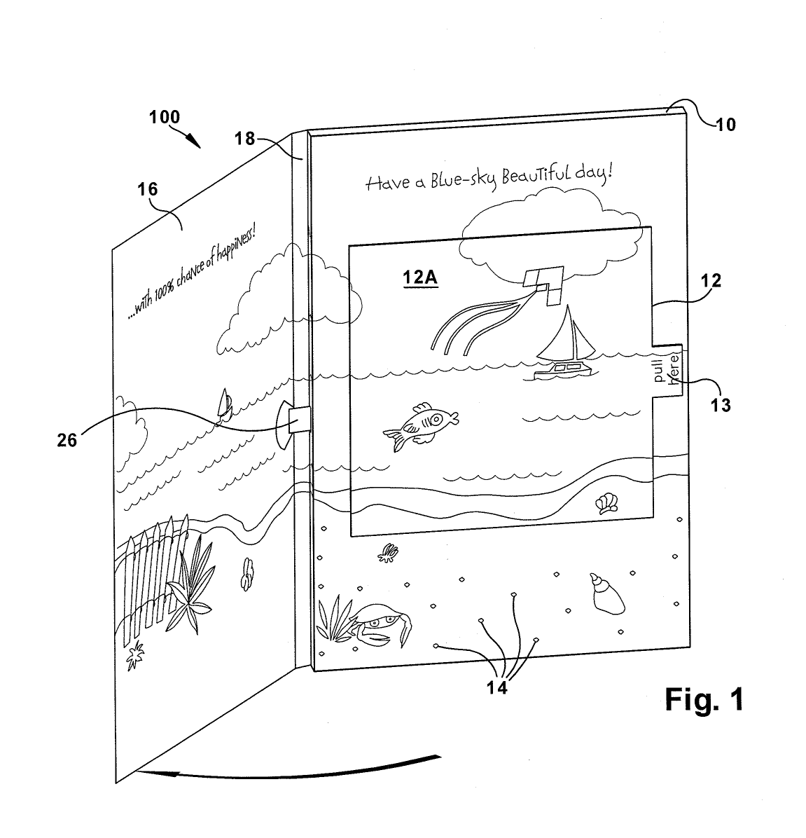

FIG. 2 is a perspective view of the greeting card of FIG. 1 with the expandable banner in an open position.

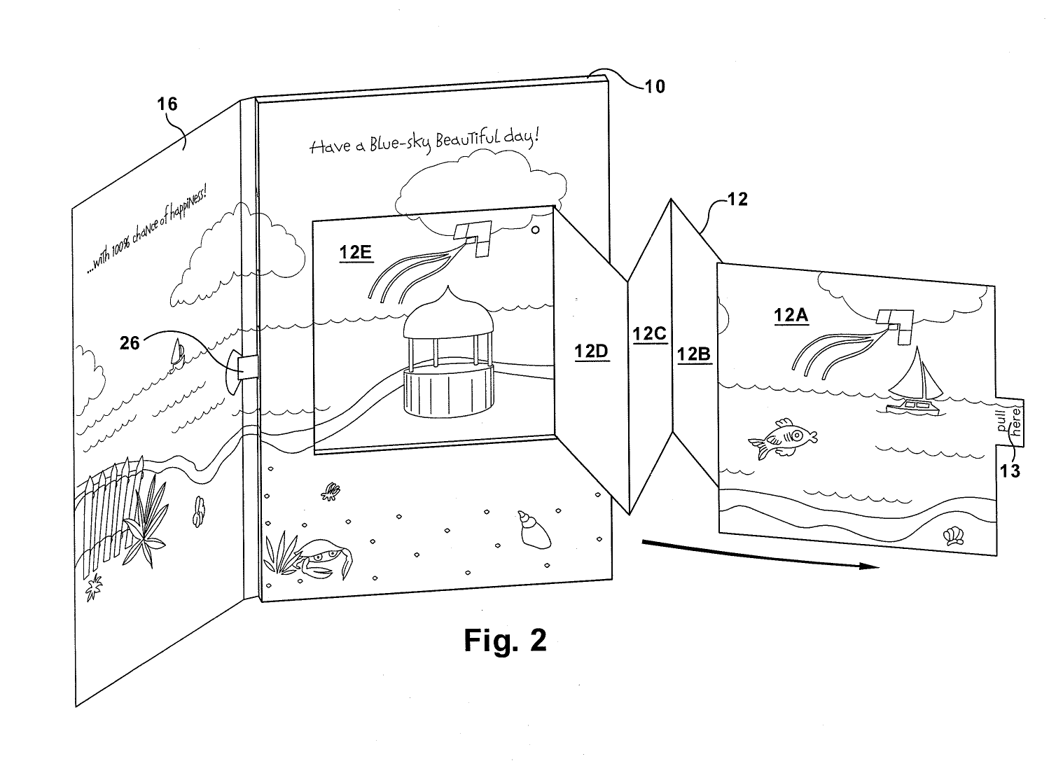

FIG. 3 is a front tear-away view of the greeting card of FIG. 1.

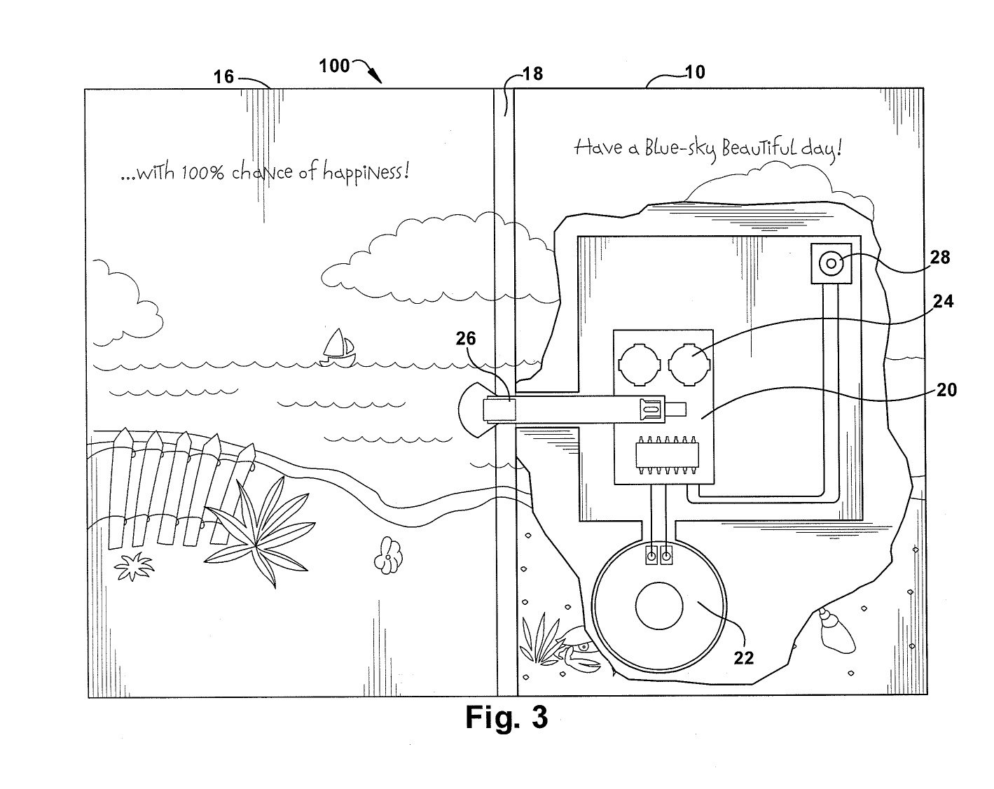

### DETAILED DESCRIPTION OF PREFERRED AND ALTERNATE EMBODIMENTS

The greeting card 100 of the present invention includes a protective housing 10 within which the electronic components are contained and concealed. The protective housing 10 is covered in a multiple panel construct or enclosure which forms a greeting card around the housing. A small compartment in a center portion of the protective housing 10 contains an expandable banner 12 which can be unfolded or pulled away from the greeting card 100 to trigger initiation of a sound clip and illumination of one or more lights 14.

In a preferred embodiment, the protective housing 10 is made of corrugate, foam or other lightweight material. The material may be a single contiguous piece or two or more pieces which are attached or connected to create the housing. The materials are formed into a frame having a generally square or rectangular shape within an opening at the center. The housing 10 has a front surface and a back surface opposite the front surface with a perimeter surface therebetween. The housing 10 may have one or more openings or cavities therein, wherein which the various electronic components are contained. For example, in a preferred embodiment, the housing 10 is a generally rectangular shaped frame made of one or more pieces of foam. The top and bottom (horizontal) sides of the frame are generally larger than the right and left (vertical) sides of the frame, to accommodate the various electronic or other components which make up the greeting card 100. One or more electronic components are stored in the top side of the frame and one or more components are stored in the bottom side of the frame. If the one or more components contained in the top side of the frame need to be in electronic contact or otherwise connected with the one or more components contained in the bottom side of the frame, wires or other connection mechanisms, can be routed through an opening in the right and/or left sides of the frame. The entire frame is covered or enclosed by a multi-panel construct or covering. In a preferred embodiment, the multi-panel construct is made of paperboard used in traditional greeting cards, but can be made of any other material. The construct completely covers the front and back surfaces of the protective housing 10 and also covers each of the inner and outer perimeter sides or edges of the housing. The multi-panel construct serves as both a functional cover for the protective housing 10 and a message delivery medium. There may be one or more small openings or apertures contained on the multi-panel construct, through which one or more LED lights 14 are visible. The multi-panel construct, extends beyond the protective housing to provide a spine 18 and cover panel 16 of the greeting card 100. The spine 18 wraps along one side edge of the housing 10 so that the cover panel 16 extends over the front surface of the covered protective housing 10. The greeting card 100 is opened by lifting the cover panel 16 and pivoting it away from the protective housing 10 about the spine 18. The cover panel 16 of the greeting card 100 is a substantially planar panel having a front surface and a back surface opposite the front surface. The front surface of the cover panel serves as the front of the greeting card 100 and the back surface of the cover panel 16 serves as the inside left panel of the greeting card 100. The front surface of the protective housing 10 serves as the inside right panel of the greeting card 100 and the back surface of the protective housing 10 serves as the back of the greeting card 100. Each panel of the multi-panel construct can be designed and decorated with the same theme and may contain various messages contained thereon.

An expandable banner 12 is inserted and secured into the compartment or area at the center of the protective frame or housing 10. The banner 12, in one embodiment is a single panel having one or more evenly spaced fold lines which create several segments or subpanels 12A-12E. Each segment or subpanel 12A-12E is folded along each fold line in alternating directions such that the segments or subpanels 12A-12E are arranged in a stacked arrangement. The sub-panel 12A is located at the top of the stack may be larger than the other subpanels 12B-12E and may contain a tab 13 to facilitate gripping the panel 12A and unfolding the remaining subpanels 12B-12E to reveal a message and/or photographs, artwork, drawings or other printed indicia or embellishments. Each sub-panel 12A-12E may contain a portion of a written message or they may contain a series of drawings or photos or other printed indicia.

Electronic components used in the greeting card 100 may include, but are not limited to: a circuit board 20; an integrated circuit; a speaker 22; a memory storage device containing one or more audio files; a power source 24 such as one or more batteries; one or more switches; one or more LED lights 14 or a plurality of fiber optic strands having a bulb at one end thereof; and any other item which is required for or which effectuate audio storage and playback and light illumination. The electronic components are contained and concealed within the protective housing or frame 10. The components may be contained in any of the four sides of the housing or frame 10. A plurality of fiber optic strands may be part of one or more bundles. The one or more bundles are contained, along with the electronic components, in one or more sides of the protective housing frame 10. Each of the bulbs contained at one end of the plurality of fiber optic strands may be routed around the frame to the plurality of openings or apertures contained on the covering or case surrounding or enclosing the protective housing, such that the bulbs are visible through said openings. The greeting card 100 may contain a single fiber optic bundle. Alternatively, one fiber optic bundle may be contained in a top portion of the protective frame 10 and a second fiber optic bundle may be contained in a bottom portion of the protective frame 10 so that each of the plurality of light bulbs can easily reach the plurality of openings in the greeting card 100 which are spaced around the entire frame 10 about the expandable banner 12.

In a preferred embodiment, a slide switch 26 is attached to the multi-panel construct between the cover panel 16 and the protective housing 10 such that when the greeting card 100 is opened by moving the cover panel 16 away from the protective housing 10 by pivoting about the spine 18, playback of an audio file is initiated. The audio file may contain music, a song, a verbal or spoken message, or any other recordable sound. A second switch 28 may work in combination with the expandable banner 12 so that when the stack of subpanels 12A-12E is unfolded, the switch 28 may initiate playback of an audio file. The second switch 28 may be a magnetic switch, wherein opposing magnets are placed within the greeting card frame 10 and the expandable banner 12 and the circuit is complete by pulling the magnets apart or a light switch, wherein a light sensor is located behind the expandable banner 12 and wherein the circuit is complete when the sensor is exposed to light.

While the greeting card has been described and shown herein as having a rectangular shape with a square/rectangular expandable banner, the greeting card and expandable banner may take any other shape. Also, the switches are described herein as being a slide switch and a magnetic and/or light switch, however any other switch types can be used. The initiation of the sound and light may be reversed or may be initiated simultaneously. The materials described herein are used to describe the preferred embodiment and other materials have been contemplated and are considered to be within the scope of the present invention. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A greeting card comprising:
a protective housing shaped as a frame with a substantial opening thereon;
a multi-panel greeting card body which covers the protective housing;
an expandable banner located within the substantial opening in the protective housing;
a sound module operative to store and playback at least one pre-recorded audio file;
a light module operative to illuminate one or more LED lights;
a first switch which controls playback of the at least one pre-recorded audio file;
a second switch which controls illumination of the one or more LED lights;
wherein the one or more LED lights are visible through one or more openings on the multi-panel greeting card body.

2. The greeting card of claim 1, wherein the protective housing is made of one or more pieces of foam.

3. The greeting card of claim 1, wherein the protective housing is made of one or more pieces of corrugate.

4. The greeting card of claim 1, wherein the one or more LED lights are each connected to a fiber optic strand.

5. The greeting card of claim 1, wherein the first switch is a slide switch.

6. The greeting card of claim 1, wherein the second switch is a magnetic switch.

7. The greeting card of claim 1, wherein the second switch is a light sensitive switch.

8. A greeting card comprising:
a rectangular foam body having an opening at the center thereof;
a multi-panel greeting card cover which encloses the rectangular foam body;
an expandable banner which is located within the opening at the center of the rectangular foam body;
a sound module contained within the rectangular foam body, the sound module operative to store and playback at least one audio file;
a light module containing a fiber optic bundle comprising a plurality of fiber optic strands, each of the plurality of fiber optic strands having an LED bulb at one end thereof which are visible through a plurality of openings on the multi-panel greeting card body;
a first switch which controls playback of the at least one audio file upon opening the greeting card;
a second switch which controls illumination of the plurality of fiber optic strands upon the expandable banner being unfolded.

9. The greeting card of claim 8, wherein the expandable banner comprises a plurality of subpanels which are folded into a stacked arrangement.

10. The greeting card of claim 8, wherein the expandable banner fills the entire opening at the center of the rectangular foam body.

11. The greeting card of claim 8, wherein the second switch is a magnetic switch.

12. The greeting card of claim 11, wherein the expandable banner contains a portion of the magnetic switch contained therein.

13. The greeting card of claim 12, wherein the protective housing contains a portion of the magnetic switch contained therein.

14. The greeting card of claim 8, wherein the plurality of openings in the greeting card body are contained on the inside of the greeting card.

15. The greeting card of claim 8, wherein the second switch is a light sensitive switch.

16. The greeting card of claim 15, wherein the expandable banner contains an opening on a portion thereof through which a light sensor is visible.

17. A greeting card comprising:
a foam frame having an expandable banner within an opening at the center thereof;
a multi-panel greeting card cover which encloses the foam frame;
a sound module contained within the foam frame, the sound module operative to store and playback at least one audio file;
a light module contained within the foam frame, the light module operative to illuminate a fiber optic bundle, the fiber optic bundle comprising a plurality of fiber optic strands, each strand having an LED bulb at one end thereof which are visible through a plurality of openings in the multi-panel greeting card cover;
wherein opening the greeting card initiates playback of the at least one audio file; and
wherein unfolding the expandable banner causes illumination of the fiber optic bundle.

18. The greeting card of claim 17, wherein the expandable banner comprises a single banner having a plurality of fold lines dividing the expandable banner into several subpanels.

19. The greeting card of claim 17, wherein the subpanels are arranged in a stacked arrangement.

20. The greeting card of claim 17, wherein unfolding the expandable banner reveals a written message.
